(19) United States
(12) Patent Application Publication
(10) Pub. No.: US 2021/0053427 A1
(43) Pub. Date: Feb. 25, 2021

(54) Embedded waterproof bed cover for pickup truck

(71) Applicant: Ningbo Crosstrip Electronic Science Co.,Ltd, Ningbo (CN)

(72) Inventors: Guanqian Gu, Ningbo (CN); Jianping Luo, Ningbo (CN)

(73) Assignee: Ningbo Crosstrip Electronic Science Co.,Ltd

(21) Appl. No.: 17/084,670

(22) Filed: Oct. 30, 2020

(30) Foreign Application Priority Data
Sep. 18, 2020 (CN) 202010986497.4

(51) Int. Cl. B60J 7/04; B60J 7/19; B60J 10/21; B60J 10/32; B60J 10/90

(52) U.S. Cl. CPC B60J 7/041; B60J 7/198; B60J 10/90; B60J 10/32; B60J 10/21

(57) ABSTRACT

The invention is relevant to the field of automobile accessories, in particular to a bed cover of vehicle, an embedded waterproof bed cover for pick-up truck includes a bed cover, the bed cover includes a guide rail, a front bar, cover plates, a rear bar and a locking device. The invention improves the waterproof effect of the bed cover by using the connecting rubber strip and the side rubber strip, thus improving the user's use experience.

### TECHNICAL FIELD

This invention is relevant to automobile accessories field, especially about the bed cover of pickup truck.

### BACKGROUND TECHNOLOGY

Pickup car, also known as the sedan truck, has a cargo hopper for loading goods; since the truck's cargo hopper is open, in order to avoid the rain from wetting the goods inside in rainy and snowy weather, people designed a bed cover and installed the cover on the cargo hopper of pickup, so as to cover the goods inside the hopper and avoid the goods from getting wet by rain. However, the effect of the existing car covers are usually not good enough because they are usually mounted on a frame and then turned over by a structure such as hinges, there are gaps between the cover plates where water drops will leak into the hopper. Meanwhile the cover plate is limited by the hinge structure when it is turned up, the angle of the cover plate is small, besides, the consistency between the car cover and the hopper is poor; moreover, it is inconvenient to fix the cover to the hopper by the existing lock, thus reduce the user's experience.

### ABOUT THE INVENTION

The purpose of the invention is to provide a kind of waterproof embedded bed cover of pick-up truck and solve at least one technical problem above.

Thus the invention use the following method:

an embedded waterproof bed cover for pickup truck includes one bed cover, wherein, the bed cover includes two guide rail respectively installed on the inner walls of both sides of the pickup truck, a front bar, four cover plates, a rear bar and three lock devices;

four cover plates include a first cover plate, a second cover plate, a third cover plate and a fourth cover plate, the said front bar, first cover plate, second cover plate, third cover plate, fourth cover plate and the rear bar are placed from front to back in sequence;

the front bar is connected with the first cover plate through the first rotating shaft structure, the first cover plate is connected with the second cover plate through the second rotating shaft structure, the second cover plate is connected with the third cover plate through the third rotating shaft structure, the third cover plate is connected with the fourth cover plate through the fourth rotating shaft structure, and the rear bar is fixed to the fourth cover plate.

three lock buckle devices are respectively arranged under the second shaft structure, the third shaft structure and the rear bar,

the upper side of the guide rail is provided with a side bar, the upper side of the side rail is provided with a waterproof rubber strip, the lower part of the waterproof rubber strip is provided with a strip-shaped bulge, the upper part of the side rail is provided with a fixed groove for clamping the strip-shaped bulge.

The cross section of the strip bulge is in a hook shape.

The first rotating shaft structure includes a first connector, a first connecting rubber strip, the first connecting rubber strip includes a first sheet-shaped rubber, the lower part of the first sheet-shaped rubber is provided with two parallel arranged first block bulges; the first groove for clamping the first block bulges is arranged above the rear part of the front bar and the front side of the first connector, the rear part of the first connector is provided with a first groove for connecting the first cover plate;

the second rotating shaft structure includes a second connector, a second connecting rubber strip, a first connecting plate, a third connecting rubber strip and a third connector, the front part of the second connector is provided with a second groove for connecting the first cover plate, the second connecting rubber strip includes a second sheet-shaped rubber, the lower part of the second sheet-shaped rubber is provided with two parallel arranged second block bulges, the second groove for clamping the second block bulges is arranged above both the rear part of the second connector and the front part of the first connecting plate; the third connecting rubber strip includes a third sheet-shaped rubber, the lower part of the third sheet-shaped rubber is provided with two parallel arranged third block bulges, the third groove for clamping the third block bulges is arranged above both the rear part of the first connector and the front part of the third connecting plate, the rear part of the third connector are provided with a third groove for connecting the second cover plate;

the third rotating shaft structure includes a fourth connector, a fourth connecting rubber strip, a second connecting plate, a fifth connecting rubber strip and a fifth connector, the front part of the fourth connector is provided with a fourth groove for connecting the second cover plate, the fourth connecting rubber strip includes a fourth sheet-shaped rubber, the lower part of the fourth sheet-shaped rubber is provided with two parallel arranged fourth block bulges, the fourth groove for clamping the fourth block bulges is arranged above the rear part of the fourth connector and the front part of the second connecting plate; the fifth connecting rubber strip includes a fifth sheet-shaped rubber, the lower part of the fifth sheet-shaped rubber is provided with two parallel arranged fifth block bulges, the fifth groove for clamping the fifth block bulges is arranged above the rear part of the fifth connector and the front part of the second connecting plate, the rear part of the fifth connector is provided with a fifth groove for connecting the third cover plate,

the fourth rotating shaft structure includes a sixth connector, a sixth connecting rubber strip, a seventh connecting plate, the front part of the sixth connector is provided with a sixth groove for connecting the third cover plate, the sixth connecting rubber strip includes a sixth sheet-shaped rubber, the lower part of the sixth sheet-shaped rubber is provided with two parallel arranged sixth block bulges, the sixth groove for clamping the sixth block bulge is arranged above the rear part of the sixth connector and the front part of the seventh connecting connector, the rear part of the seventh connector is provided with a seventh groove for connecting the fourth cover plate;

wherein, the length of the first connecting plate is not less than the second connecting plate.

A first sag for embedding the first sheet-shaped rubber is arranged on the front bar and the first connector; a second sag for embedding the second sheet-shaped rubber is arranged on the second connector and the first connecting plate; a third sag for embedding the third sheet-shaped rubber is arranged on the first connecting plate and the third connector; a fourth sag for embedding the fourth sheet-shaped rubber the fourth connector and the second connecting plate; a fifth sag for embedding the fifth sheet-shaped rubber is arranged on the second connecting plate and the fifth connector; a sixth sag, for embedding the sixth sheet-shaped rubber is arranged on, the sixth connector and the seventh connector. The rear side of the front bar is provided with a first pressing handle, the front side of the first connector is provided with a second pressing handle which is used to against the first pressing handle, both the first pressing handle and the second pressing handle are using one-piece sheet bulge, the first pressing handle and the second pressing handle are inclined arranged below the first groove;

the rear side of the second connector is provided with a third pressing handle, the front side of the first connecting plate is provided with a fourth pressing handle which is used to against the third pressing handle, both the third pressing handle and the fourth pressing handle are using one-piece sheet bulge, the third pressing handle and the fourth pressing handle are inclined arranged below the second groove;

the rear side of the first connecting plate is provided with a fifth pressing handle, the front side of the third connector is provided with a sixth pressing handle which is used to against the fifth pressing handle, both the fifth pressing handle and the sixth pressing handle are using one-piece sheet bulge, the fifth pressing handle and the sixth pressing handle are inclined arranged below the third groove; the rear side of the fourth connector is provided with a seventh pressing handle, the front side of the second connecting plate is provided with a eighth pressing handle which is used to against the seventh pressing handle, both the seventh pressing handle and the eighth pressing handle are using one-piece sheet bulge, the seventh pressing handle and the eighth pressing handle are inclined arranged below the fourth groove;

the rear side of the second connecting plate is provided with a ninth pressing handle, the front side of the fifth connector is provided with a tenth pressing handle which is used to against the ninth pressing handle, both the ninth pressing handle and the tenth pressing handle are using one-piece sheet bulge, the ninth pressing handle and the tenth pressing handle are inclined arranged below the fifth groove;

the rear side of the sixth connector is provided with a eleventh, pressing handle, the front side of the seventh connector is provided with a twelfth pressing handle which is used to against the eleventh pressing handle, both the eleventh pressing handle and the twelfth pressing handle are using one-piece sheet bulge, the eleventh pressing handle and the twelfth pressing handle are inclined arranged below the sixth groove.

The cross-sections of the lower part of the first block bulge, the lower part of the second block bulge, the lower part of the third block bulge, the lower part of the fourth block bulge, the lower part of the fifth block bulge and the lower section of the sixth block bulge all in excellent arc-shape.

The second rotating shaft structure, the third rotating shaft structure and the lower part of the rear bar are provided with a long strip-shaped mounting slot wherein said locking device is arranged at the mounting slot;

the locking device includes two locking tab bases which are respectively arranged at, both ends of the mounting slot;

the locking tab base is provided with a first strip groove, the first strip groove is provided with a locking tab, a first locking tab block and second locking tab block are arranged inside the first strip groove, the locking tab is arranged between the first locking tab block and the second locking tab block, the second locking tab block is provided with a first through hole, the locking tab is connected with a connecting pole with a circular cross section, the diameter of the front part of the connecting pole is smaller than that of the rear part, the front part of the connecting pole passes through the first through hole, a spring is arranged outside the connecting pole and arranged between the locking tab and the second locking tab block;

the connecting pole inside the two lock tab bases are connected by a steel wire rope;

the locking device includes two handle bases which are respectively arranged on both sides of the mounting slot;

the handle base is provided with a second strip groove, a second through hole for connecting the second strip groove is arranged above both side of the handle base, the steel wire rope passes through the second through hole and the second strip groove, the second strip groove is provided with two guide rods for guiding the steel wire rope to change direction, two guide rods are arranged on both sides of the second strip groove, the steel wire rope is connected with a rubber handle through a handle belt, the joint of the steel wire rope and the handle belt is arranged between the two guide rods;

the locking device includes two locking tab sleeves, the locking tab includes a cylinder, the cylinder is arranged under the first locking tab block, the locking tab sleeve is provided with a limit groove for clamping the cylinder, the locking tab sleeve is fixed on the guide rail.

The cross section of the limit groove is in a “U” shape.

The handle belt includes a first ferrule, a connecting belt and a second ferrule, the first ferrule is arranged outside the steel wire rope, the first ferrule is arranged between the two guide rods, the first ferrule is connected to the second ferrule through the connecting belt, the rubber handle includes a cross rod, the second ferrule is arranged outside of cross rod.

The mounting slot is arranged at the lower part of the second connector, the fourth connector and the rear bar.

The lower part of the front bar is provided with a buckle device for fixing and connecting the guide rail;

the buckle device includes a screw, a fixing block, the fixing block is provided with a third through hole, the screw passes through the third through hole, the upper part of the screw is fixed under the front bar, the screw is, screwed with a nut which is arranged below the fixing block, one end of the fixing block extends into the slot of the guide rail.

Through this design, the invention provides an embedded waterproof bed cover for pickup truck, which is convenient to use. In this design, the bed cover is installed on the cargo hopper of the pickup truck as a whole, and the structure of the front bar, the cover plate and the back rail formed a sealed space, and the waterproof effect of the cover greatly improved by using the connecting rubber strip and the side rubber strip; furthermore, the cover plate of the cover can be turned up at a large angle, moreover the locking device is convenient to use, which improves the user's experience.

### DESCRIPTION OF DRAWINGS

FIG. 1 is a partial structure illustration of the bed cover in the invention

FIG. 2 is a bottom view of the partial structure of the bed cover in the invention

FIG. 3 is a partial structural side view of the bed cover in the invention;

FIG. 4 is a partial structure section illustration of the third rotating shaft structure of the invention;

FIG. 5 is a partial structure section illustration of the fourth connecting rubber strip in the invention;

FIG. 6 is a partial structure illustration of the side bar waterproof adhesive strip in the invention;

FIG. 7 is a partial structure section illustration of the side bar waterproof adhesive strip in the invention;

FIG. 8 is a partial structure illustration of the buckle device in the invention;

FIG. 9 is a partial structure illustration of the locking tab sleeve in the invention;

FIG. 10 is a partial structure illustration of the locking, tab base in the invention;

FIG. 11 is a partial structure illustration of the handle base in the invention.

### THE CONCRETE METHOD TO CARRY OUT

The following instruction is to further explain the concrete implementation method in the invention.

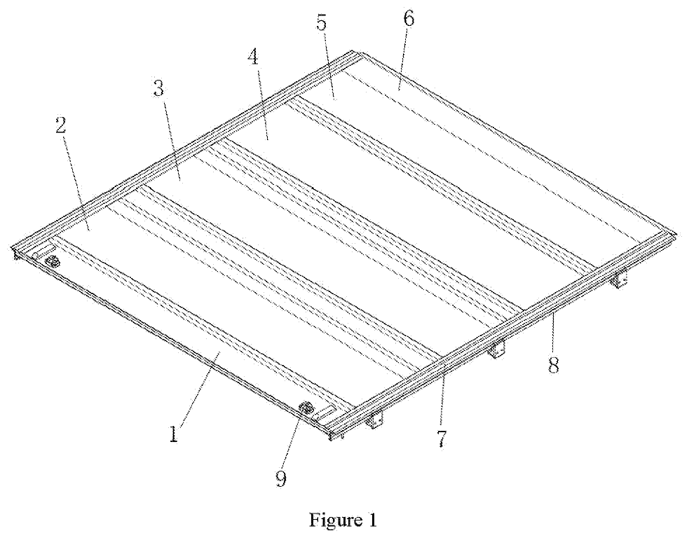

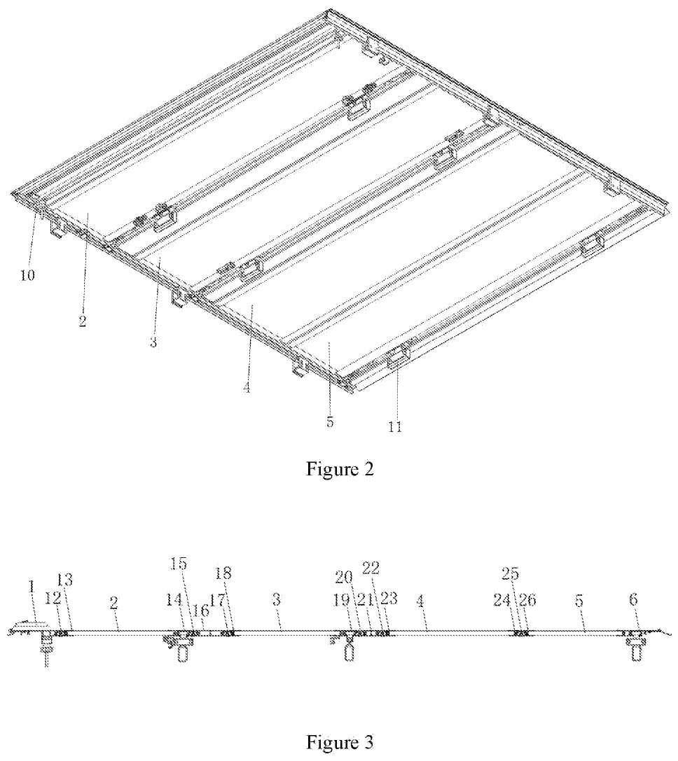

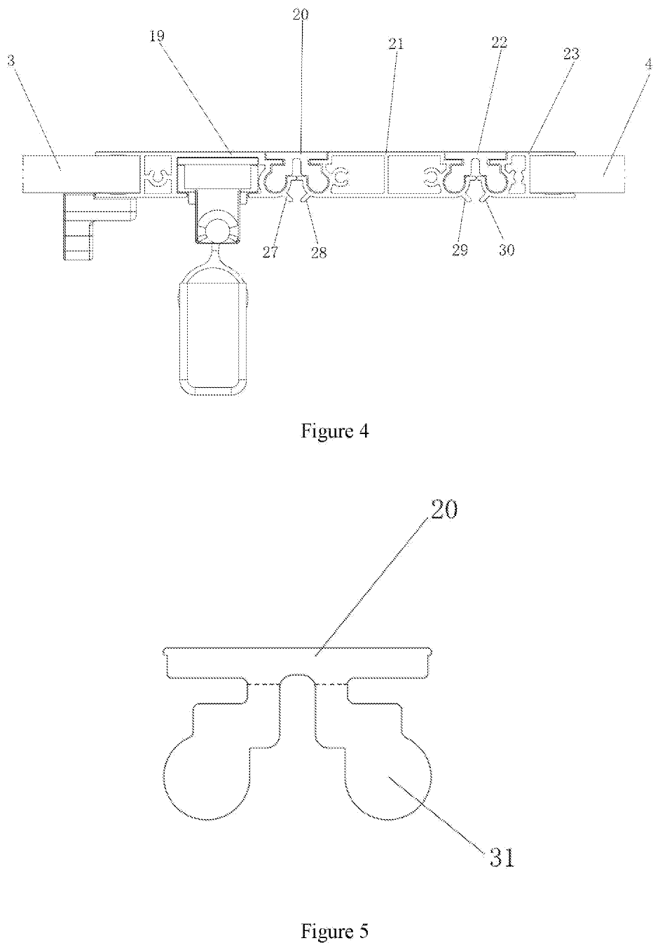

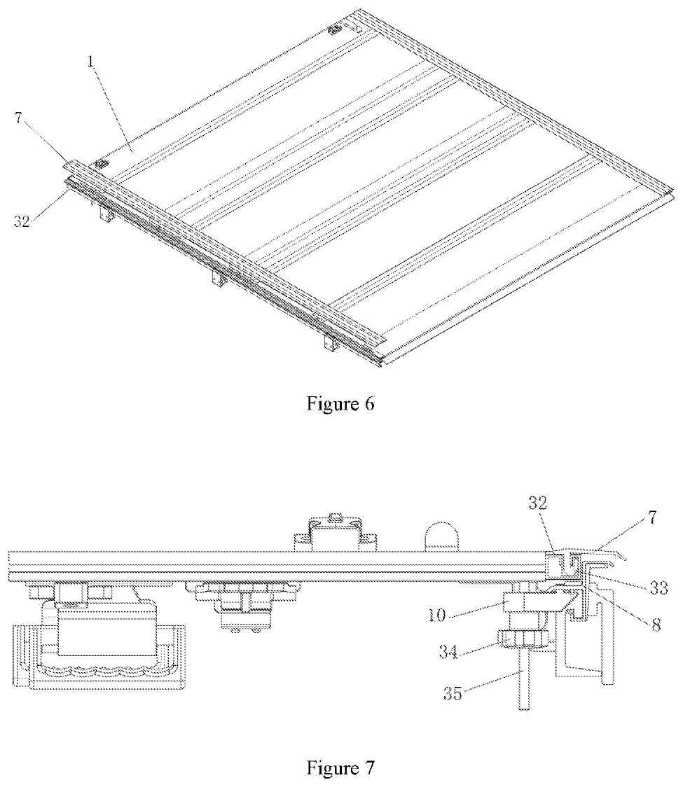

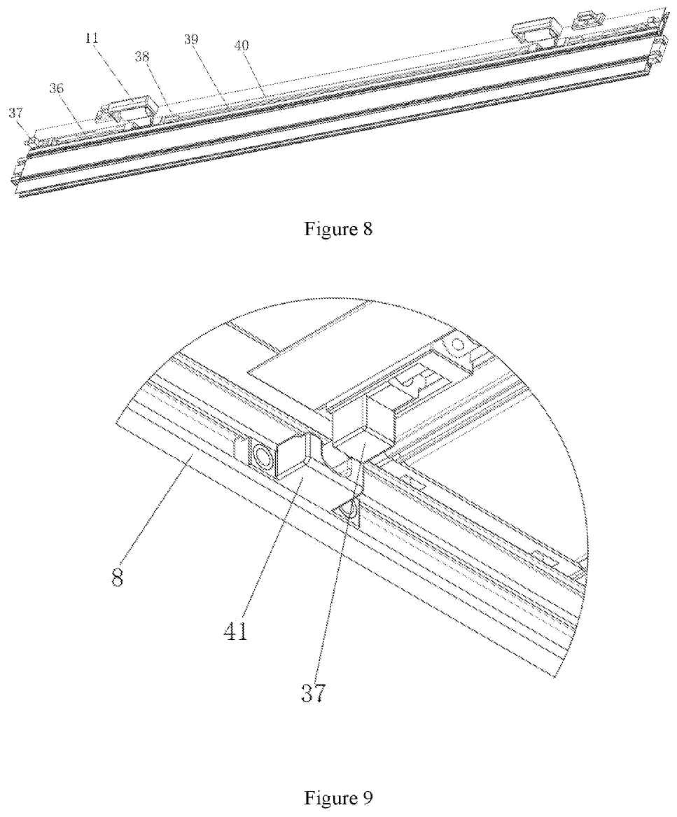

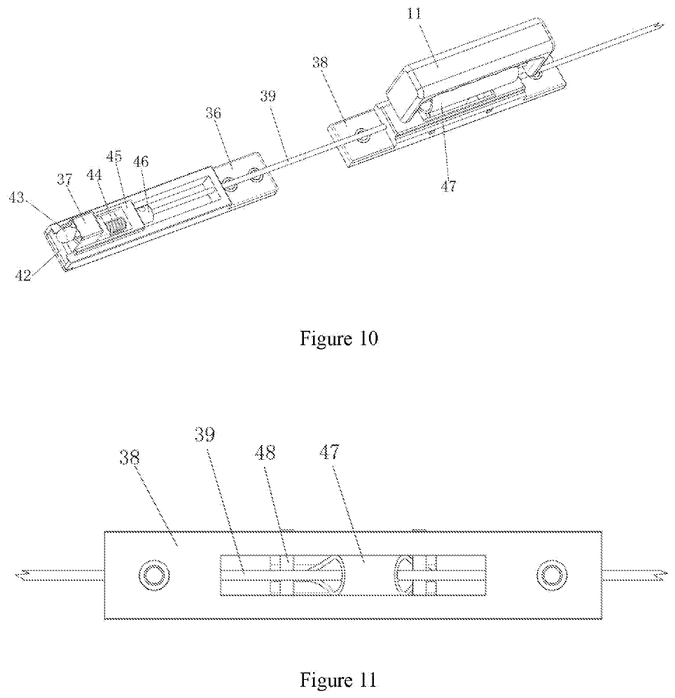

As is seen from FIGS. 1 to 1, an embedded waterproof bed cover for pickup truck includes one bed cover, the bed cover includes two guide rail 8 which are respectively installed on the inner walls of both sides of the pickup truck, a front bar 1, four cover plates, a rear bar 6 and three lock devices; four cover plates include a first cover plate 1, a second cover plate 3, a third cover plate 4 and a fourth cover plate 5, wherein said front bar, first cover plate, second cover plate, third cover plate, fourth cover plate and the rear bar are placed from front to back in sequence; the front bar is connected with the first cover plate through the first rotating shaft structure, the first cover plate is connected with the second cover plate through the second rotating shaft structure, the second cover plate is connected with the third cover plate through the third rotating shaft structure, the third cover plate is connected with the fourth cover plate through the fourth rotating shaft structure, the rear bar is fixed to the fourth cover plate; three lock buckle devices are respectively arranged below the second shaft structure, the third shaft structure and the rear bar; the upper side of the guide rail is provided with a side bar 32, the upper side of the side rail is provided with a waterproof rubber strip 7, the lower part of the waterproof rubber strip is provided with a strip-shaped bulge 33, the upper part of the side rail is provided with a fixed groove for clamping the strip-shaped bulge. Through this design, the invention provides an embedded waterproof bed cover for pickup truck, which is convenient to use. In this design, the bed cover is installed on the cargo hopper of the pickup truck as a whole, the structure of the front bar, the cover plate and the back rail fainted a sealed space, and the waterproof effect of the cover greatly improved by using the connecting rubber strip and the side rubber strip; furthermore, the cover plate of the cover can be turned up at a large angle, moreover the locking device is convenient to use, which improves the user's experience.

In order to ensure the strength of the connection between side bar waterproof tape and side bar, the cross section of the strip bulge is in a hook shape.

The first rotating shaft structure includes a first connector 13, a first connecting rubber strip 12, the first connecting rubber strip includes a first sheet-shaped rubber, the lower part of the first sheet-shaped rubber is provided with two parallel arranged first block bulge; the rear part of the front bar and the front part of the first connector are provided with a first groove for clamping the first block bulge, the rear part of the first connector is provided with a first groove for connecting the first cover plate; the second rotating shaft structure includes a second connector 14, a second connecting rubber strip 15, a first connecting plate 16, a third connecting rubber strip 17 and a third connector 18, the front part of the second connector is provided with a second groove for connecting the first cover plate, the second connecting rubber strip includes a second sheet-shaped rubber, the lower part of the second sheet-shaped rubber is provided with two parallel arranged second block bulge, the rear part of the second connector and the front part of the first connecting plate are provided with a second groove for clamping the second block bulge; the third connecting rubber strip includes a third sheet-shaped rubber, the lower part of the third sheet-shaped rubber is provided with two parallel arranged third block bulge, the rear part of the first connector and the front part of the third connecting plate are provided with a third groove for connecting the second cover plate; the third rotating shaft structure includes a fourth connector 19, a fourth connecting rubber strip 20, a second connecting plate 21, a fifth connecting rubber strip 22 and a fifth connector 23, the front part of the fourth connector is provided with a fourth groove for connecting the second cover plate, the fourth connecting rubber strip includes a fourth sheet-shaped rubber, the lower part of the fourth sheet-shaped rubber is provided with two parallel arranged fourth block bulge 31, the rear part of the fourth connector and the front part of the second connecting plate are provided with a fourth groove for clamping the fourth block bulge; the fifth connecting rubber strip includes a fifth sheet-shaped rubber, the lower part of the fifth sheet-shaped rubber is provided with two parallel arranged fifth block bulge, the rear part of the fifth connector is provided with a fifth groove for connecting the third cover plate; the fourth rotating shaft structure includes a sixth connector 24, a sixth connecting rubber strip 25, a seventh connecting plate 26, the front part of the sixth connector is provided with a sixth groove for connecting the third cover plate, the sixth connecting rubber strip includes a sixth sheet-shaped rubber, the lower part of the sixth sheet-shaped rubber is provided with two parallel arranged sixth block bulge, the rear part of the sixth connector and the front part of the seventh connecting connector are provided with a sixth groove for clamping the sixth block bulge, the rear part of the seventh connector is provided with a seventh groove for connecting the fourth cover plate; the length of the first connecting plate is not less than the second connecting plate. The front part of the rear bar is provided with an eighth embedding groove for connecting the fourth cover plate. The connection part of the rotating shaft structure adopts the waterproof rubber strip, the upper part of the rubber strip is used to cover the shaft structure to prevent rainwater from penetrating inside while the lower part of the rubber strip is tightly stuck into the groove to further reduce the rainwater infiltration; moreover, the flexible rubber strip makes the overturning angle of the cover plate larger, it allows the adjacent two cover plates to be overturned up to 180° without using a rotating shaft; this design also enables the cover plate to be turned, up and folded in turn, the fourth cover plate, the third cover plate, the second cover plate and the first cover plate can be turned up and fold in turn, the folded cover plate can be stored above the front bar, which reduces the storage volume and facilitates users to use the truck hopper.

A first sag for embedding the first sheet-shaped rubber is arranged on the front bar and the first connector; a second sag for embedding the second sheet-shaped rubber is arranged on the second connector and the first connecting plate; a third sag for embedding the third sheet-shaped rubber is arranged on the first connecting plate and the third connector; a fourth sag for embedding the fourth sheet-shaped rubber the fourth connector and the second connecting plate, a fifth sag for embedding the fifth sheet-shaped rubber is arranged on the second connecting plate and the fifth connector; a sixth sag for embedding the sixth sheet-shaped rubber is arranged on the sixth connector and the seventh connector. The upper surface of the connecting strip is parallel to the upper surface of the cover plate which makes the bed cover more tidy.

The rear side of the front bar is provided with a first pressing handle, the front side of the first connector is provided with a second pressing handle which is used to against the first pressing handle, both the first pressing handle and the second pressing handle are using one-piece sheet bulge, the first pressing handle and the second pressing handle are inclined arranged below the first groove; the rear side of the second connector is provided with a third pressing handle, the front side of the first connecting plate is provided with a fourth pressing handle which is used to against the third pressing handle, both the third pressing handle and the fourth pressing handle are using one-piece sheet bulge, the third pressing handle and the fourth pressing handle are inclined arranged below the second groove; the rear side of the first connecting plate is provided with a fifth pressing handle, the front side of the third connector is provided with a sixth pressing handle which is used to against the fifth pressing handle, both the fifth pressing handle and the sixth pressing handle are using one-piece sheet bulge, the fifth pressing handle and the sixth pressing handle are inclined arranged below the third groove; the rear side of the fourth connector is provided with a seventh pressing handle 27, the front side of the second connecting plate is provided with a eighth pressing handle 28 which is used to against the seventh pressing handle, both the seventh pressing handle and the eighth pressing handle are using one-piece sheet bulge, the seventh pressing handle and the eighth pressing handle are inclined arranged below the fourth groove; the rear side of the second connecting plate is provided with a ninth pressing handle 29, the front side of the fifth connector is provided with a tenth pressing handle 30 which is used to against the ninth pressing handle, both the ninth pressing handle and the tenth pressing handle are using one-piece sheet bulge, the ninth pressing handle and the tenth pressing handle are inclined arranged below the fifth groove; the rear side of the sixth connector is provided with a eleventh pressing handle, the front side of the seventh connector is provided with a twelfth pressing handle which is used to against the eleventh pressing handle, both the eleventh pressing handle and the twelfth pressing handle are using one-piece sheet bulge, the eleventh pressing handle and the twelfth pressing handle are inclined arranged below the sixth groove. After the car cover is assembled, the cover plates of the car cover will be pressed against each other, the adjacent two pressing handles also resist each other, so that the profile at this place will deform to a certain extent, thus make the upper part of the connecting rubber strip form a protruding arc surface, so as to achieve better waterproof effect.

In order to ensure the sealing effect, the cross-sections of the lower part of the first block bulge, the lower part of the second block bulge, the lower part of the third block bulge, the lower part of the fourth block bulge, the lower part of the fifth block bulge and the lower part of the sixth block bulge all in excellent arc-shape, which makes the lower part of the rubber strip is tightly clamped into the groove which further play a waterproof role.

The lower part of the second rotating shaft structure, the third rotating shaft structure and the rear bar are provided with a long strip-shaped mounting slot 40, the locking device is arranged at the mounting slot; the locking device includes two locking, tab bases 36 which are respectively arranged at both ends of the mounting slot; the locking tab base is provided with a first strip groove, the first strip groove is provided with a locking tab 37, a first locking tab block and a second locking tab block 45 are arranged inside the first strip groove 42, the locking tab is arranged between the first locking tab block and the second locking tab block, the second locking tab block is provided with a first through hole, the locking tab is connected with a circular connecting pole 46 with a round cross section, the diameter of the front part of the connecting pole is smaller than that of the rear part, the front part of the connecting pole passes through the first through hole the spring 44 is arranged outside of the connecting pole, the spring is arranged between the locking tab and the second locking tab block; the connecting pole inside the two lock tab base are connected by, a steel wire rope 39; the locking device includes two handle bases 38 which are respectively arranged on both sides of the mounting slot; the handle base is provided with a second strip groove, a second through hole for connecting the second strip groove is arranged above both side of the handle base, the steel wire rope passes through the second through hole and the second strip groove, the second strip groove is provided with two guide rods 48 for guiding the steel wire rope to change direction, two guide rods are arranged on both sides of the second strip groove, the steel wire rope is connected with a rubber handlel 1 through a handle belt 47, the joint of the steel wire rope and the handle belt is arranged between the two guide rods; the locking device includes two locking tab sleeves 41, the locking tab includes a cylinder 43, the cylinder is arranged under the first locking tab block, the locking tab sleeve is provided with a limit groove for clamping the cylinder, the locking tab sleeve is fixed on the guide rail. When any rubber handle in the lock device is pulled, the movable locking tab on both sides of the mounting slot will move in opposite direction, which will make the locking tab come out of the locking tab sleeve and open the bed cover; when the rubber handle is released, the locking tab will return to its original position under the action of spring and close the bed cover.

In order to reduce the wear of the wire rope, the guide rod can use cylindrical pins and the connecting pole is made of stainless steel.

The cross section of the limit groove is U-shaped which is convenient for the cylinder on the lock tab to extend into the lock tab sleeve.

In order to facilitate users to open and close the bed cover, the handle belt includes a first ferrule, a connecting belt and a second ferrule, the first ferrule is arranged outside the steel wire rope, the first ferrule is arranged between the two guide rods, the first ferrule is connected with the second ferrule through the connecting belt, the rubber handle includes a cross rod, the second ferrule is arranged outside of cross rod. The locking tab sleeve is fixed to the guide rail by bolts. The mounting slot is arranged at the lower part of the second connector, the fourth connector and the rear bar.

The lower part of the front bar is provided with a buckle device for connecting and fixing the guide rail; the buckle device includes a screw 35, a fixing block 10, the fixing block is provided with a third through hole, the screw passes through the third through hole, the upper part of the screw is fixed under the front bar, the screw is screwed with a nut 34, which is arranged below the fixing block, one end of the fixing block extends into the slot of the guide rail. The nuts may use the quincunx type. When the nut is tightened, the fixing block is pushed upward to compress the guide rail, meanwhile, the front bar is tightened and fixed by the screw, which make the installation of the car cover more stable. The lower part of the guide rail is fixed on the inner wall of the hopper directly or by a clamping clip. The upper part of the clip component is used to clamp and load the guide rail, and the lower part of the clip component is fixed on the inner wall of the hopper by bolts. The lower part of the guide rail is easily to incline inward when it is stressed, the fixed block of the buckle device can resist the guide rail and corrects the inversion of the guide rail.

In order to improve the waterproof effect of the bed cover, the front side of the front bar and the rear side part of the rear bar are provided with a sheet-shaped rubber for waterproof. The sheet-shaped rubber with arc-shape on the upper surface are obliquely arranged on the front and rear bars receptively.

The front bar is provided with a buckle 9 for binding the bonds. The bond is used to fix the bed cover and maintain, the folding state when the user lifts up and folds the bed cover, so as to facilitate the user to use the cargo hopper of the pickup truck.

Finally, it should be noted that: the above is only the preferred embodiment of the invention, and is not used to limit the invention. Although the present invention has been described in detail with reference to the above-mentioned embodiment, for those skilled in the art, it can still modify the technical solutions recorded in the above-mentioned embodiment, or replace some of the technical features of the same. Any modification, equivalent replacement, improvement, etc. made within the spirit and principle of the invention shall be included in the scope of protection of the invention.

1. An embedded waterproof bed cover for pickup truck includes one bed cover, wherein said bed cover includes two guide rails respectively installed on the inner walls of both sides of the pickup truck, a front bar, four cover plates, a rear bar and three lock devices;
four cover plates include a first cover plate, a second cover plate, a third cover plate and a fourth cover plate, the said front bar, first cover plate, second cover plate, third cover plate, fourth cover plate and the rear bar are placed from front to back in sequence;
the front bar is connected with the first cover plate through the first rotating shaft structure, the first cover plate is connected with the second cover plate through the second rotating shaft structure, the second cover plate is connected with the third cover plate through the third rotating shaft structure, the third cover plate is connected with the fourth cover plate through the fourth rotating shaft structure, and the rear bar is fixed to the fourth cover plate;
three lock buckle devices are respectively arranged under the second shaft structure, the third shaft structure and the rear bar;
the upper side of the guide rail is provided with a side bar, the upper side of the side rail is provided with a waterproof rubber strip, the lower part of the waterproof rubber strip is provided with a strip-shaped bulge, the upper part of the side rail is provided with a fixed groove for clamping the strip-shaped bulge.

2. The embedded waterproof bed cover for the pickup truck according to claim 1, wherein, the cross section of the strip bulge is a hook shape.

3. The embedded waterproof bed cover for the pickup truck according to claim 1, wherein said first rotating shaft structure includes a first connector, a first connecting rubber strip; the first connecting rubber strip includes a first sheet-shaped rubber, the lower part of the first sheet-shaped rubber is provided with two parallel arranged first block bulges; the first groove for clamping the first block bulges is arranged above the rear part of the front bar and the front part of the first connector, the rear part of the first connector is provided with a first groove for connecting the first cover plate;
the second rotating shaft structure includes a second connector, a second connecting rubber strip, a first connecting plate, a third connecting rubber strip and a third connector, the front part of the second connector is provided with a second groove for connecting the first cover plate, the second connecting rubber strip includes a second sheet-shaped rubber, the lower part of the second sheet-shaped rubber is provided with two parallel arranged second block bulges, the second groove for clamping the second block bulges is arranged above both the rear part of the second connector and the front part of the first connecting plate; the third connecting rubber strip includes a third sheet-shaped rubber, the lower part of the third sheet-shaped rubber is provided with two parallel arranged third block bulges, the third groove for clamping the third block bulges is arranged above both the rear part of the first connector and the front part of the third connecting plate, the rear part of the third connector are provided with a third groove for connecting the second cover plate;
the third rotating shaft structure includes a fourth connector, a fourth connecting rubber strip, a second connecting plate, a fifth connecting rubber strip and a fifth connector, the front part of the fourth connector is provided with a fourth groove for connecting the second cover plate, the fourth connecting rubber strip includes a fourth sheet-shaped rubber, the lower part of the fourth sheet-shaped rubber is provided with two parallel arranged fourth block bulges, the fourth groove for clamping the fourth block bulges is arranged above the rear part of the fourth connector and the front part of the second connecting plate; the fifth connecting rubber strip includes a fifth sheet-shaped rubber, the lower part of the fifth sheet-shaped rubber is provided with two parallel arranged fifth block bulges, the fifth groove for clamping the fifth block bulges is arranged above the rear part of the fifth connector and the front part of the second connecting plate, the rear part of the fifth connector is provided with a fifth groove for connecting the third cover plate;
the fourth rotating shaft structure includes a sixth connector, a sixth connecting rubber strip, a seventh connecting plate, the front part of the sixth connector is provided with a sixth groove for connecting the third cover plate, the sixth connecting rubber strip includes a sixth sheet-shaped rubber, the lower part of the sixth sheet-shaped rubber is provided with two parallel arranged sixth block bulges, the sixth groove for clamping the sixth block bulge is arranged above the rear part of the sixth connector and the front part of the seventh connecting connector, the rear part of the seventh connector is provided with a seventh groove for connecting the fourth cover plate;
the length of the first connecting plate is not less than the second connecting plate.

4. The embedded waterproof bed cover for pickup truck according to claim 3, wherein, a first sag for embedding the first sheet-shaped rubber is arranged on the front bar and the first connector; a second sag for embedding the second sheet-shaped rubber is arranged on the second connector and the first connecting plate; a third sag for embedding the third sheet-shaped rubber is arranged on the first connecting plate and the third connector; a fourth sag for embedding the fourth sheet-shaped rubber the fourth connector and the second connecting plate; a fifth sag for embedding the fifth sheet-shaped rubber is arranged on the second connecting plate and the fifth connector; a sixth sag, for embedding the sixth sheet-shaped rubber is arranged on the sixth connector and the seventh connector.

5. The embedded waterproof bed cover for pickup truck according to claim 3, wherein, the rear side of the front bar is provided with a first pressing handle, the front side of the first connector is provided with a second pressing handle which is used to against the first pressing handle, both the first pressing handle and the second pressing handle are using one-piece sheet bulge, the first pressing handle and the second pressing handle are inclined arranged below the first groove;
the rear side of the second connector is provided with a third pressing handle, the front side of the first connecting plate is provided with a fourth pressing handle which is used to against the third pressing handle, both the third pressing handle and the fourth pressing handle are using one-piece sheet bulge, the third pressing handle and the fourth pressing handle are inclined arranged below the second groove;
the rear side of the first connecting plate is provided with a fifth pressing handle, the front side of the third connector is provided with a sixth pressing handle which is used to against the fifth pressing handle, both the fifth pressing handle and the sixth pressing handle are using one-piece sheet bulge, the fifth pressing handle and the sixth pressing handle are inclined arranged below the third groove;
the rear side of the fourth connector is provided with a seventh pressing handle, the front side of the second connecting plate is provided with a eighth pressing handle which is used to against the seventh pressing handle, both the seventh pressing handle and the eighth pressing handle are using one-piece sheet bulge, the seventh pressing handle and the eighth pressing handle are inclined arranged below the fourth groove;
the rear side of the second connecting, plate is provided with a ninth pressing handle, the front side of the fifth connector is provided with a tenth pressing handle which is used to against the ninth pressing handle, both the ninth pressing handle and the tenth pressing handle are using one-piece sheet bulge, the ninth pressing handle and the tenth pressing handle are inclined arranged below the fifth groove;
the rear side of the sixth connector is provided with a eleventh pressing handle, the front side of the seventh connector is provided with a twelfth pressing handle which is used to against the eleventh pressing handle, both the eleventh pressing handle and the twelfth pressing handle are using one-piece sheet bulge, the eleventh pressing handle and the twelfth pressing handle are inclined arranged below the sixth groove.

6. The embedded waterproof bed cover for pickup truck according to claim 3, wherein, cross-sections of the lower part of the first block bulge, the lower part of the second block bulge, the lower part of the third block bulge, the lower part of the fourth block bulge, the lower part of the fifth block bulge and the lower part of the sixth block bulge all in excellent arc-shape.

7. The embedded waterproof bed cover for pickup truck according to claim 3, wherein, the second rotating shaft structure, the third rotating shaft structure and the lower part of the rear bar are provided with a long strip-shaped mounting slot, the said locking device is arranged at the mounting slot;
the locking device includes two locking tab bases, which are respectively arranged at both ends of the mounting slot;
the locking tab base is provided with a first strip groove, the first strip groove is provided with a locking tab, a first locking tab block and a second locking tab block are arranged inside the first strip groove, the locking tab is arranged between the first locking tab block and the second locking tab block, the second locking tab block is provided with a first through hole, the locking tab is connected with a connecting pole with a circular cross section, the diameter of the front part of the connecting pole is smaller than that of the rear part, the front part of the connecting pole passes through the first through hole, a spring is arranged outside the connecting pole and arranged between the locking tab and the second locking tab block;
the connecting pole inside the two lock tab bases are connected by a steel wire rope;
the locking device includes two handle bases, which are respectively arranged on both sides of the mounting slot;
the handle base is provided with a second strip groove, a second through hole for connecting the second strip groove is arranged above both side of the handle base, the steel wire rope passes through the second through hole and the second strip groove, the second strip groove is provided with two guide rods for guiding the steel wire rope to change direction, two guide rods are arranged on both sides of the second strip groove, the steel wire rope is connected with a rubber handle through a handle belt, the joint of the steel wire rope and the handle belt is arranged between the two guide rods;
the locking device includes two locking tab sleeves, the locking tab includes a cylinder, the cylinder is arranged under the first locking tab block, the locking tab sleeve is provided with a limit groove for clamping the cylinder, the locking, tab sleeve is fixed on the guide rail.

8. The embedded waterproof bed cover for pickup truck according to claim 7, wherein, the cross section of the limit groove is in a “U” shape.

9. The embedded waterproof bed cover for pickup truck according to claim 7, wherein, the handle belt includes a first ferrule, a connecting belt and a second ferrule, the first ferrule is arranged outside the steel wire rope, the first ferrule is arranged between the two guide rods, the first ferrule is connected to the second ferrule through the connecting belt, the rubber handle includes a cross rod, the second ferrule is arranged outside of cross rod.

10. The embedded waterproof bed cover for pickup truck according to claim 1, wherein, the lower part of the front bar is provided with a buckle device for fixing and connecting the guide rail;
the buckle device includes a screw, a fixing block, the fixing block is provided with a third through hole, the screw passes through the third through hole, the upper part of the screw is fixed under the front bar, the screw is, screwed with a nut which is arranged below the fixing block, one end of the fixing block extends into the slot of the guide rail.
